(19) United States
(12) Patent Application Publication
(10) Pub. No.: US 2026/0204602 A1
(43) Pub. Date: Jul. 16, 2026

(54) FUEL CELL SYSTEM

(71) Applicant: TOYOTA JIDOSHA KABUSHIKI KAISHA, Toyota-shi (JP)

(72) Inventor: Chiaki KATAOKA, Nagakute-shi (JP)

(73) Assignee: TOYOTA JIDOSHA KABUSHIKI KAISHA, Toyota-shi (JP)

(21) Appl. No.: 19/390,727

(22) Filed: Nov. 17, 2025

(30) Foreign Application Priority Data
Jan. 15, 2025 (JP) 2025-005249

(51) Int. Cl. H01M 8/04082; H01M 8/0444

(52) U.S. Cl. CPC H01M 8/04216; H01M 8/04447

(57) ABSTRACT

A fuel cell system includes a housing and a fuel cell disposed inside the housing. A gas discharge hole and a hydrogen detection sensor are provided at an upper portion of the housing in a state in which the housing is installed, and an outside air introduction hole is provided at a lower portion of the housing in the state in which the housing is installed.

### CROSS-REFERENCE TO RELATED APPLICATION

This application claims priority to Japanese Patent Application No. 2025-005249 filed on January 15, 2025. The disclosure of the above-identified application, including the specification, drawings, and claims, is incorporated by reference herein in its entirety.

### BACKGROUND

### 1. Technical Field

The present disclosure relates to a fuel cell system.

### 2. Description of Related Art

In Japanese Unexamined Patent Application Publication No. 2024-044718 (JP 2024-044718 A), a fuel cell disposed in a housing is provided with an inlet 31 for introducing air into the housing and an outlet 39 for discharging exhaust gas from the fuel cell, and a fan 73 for blowing air to a heat exchanger 72 is also provided.

### SUMMARY

When a fuel cell is used for a non-vehicle application such as a stationary application, it is necessary to take precautions against hydrogen leakage.

Therefore, an object of the present disclosure is to provide a fuel cell system with precautions against hydrogen leakage.

The present application discloses a fuel cell system including a housing and a fuel cell disposed inside the housing. A gas discharge hole and a hydrogen detection sensor are provided at an upper portion of the housing in a state in which the housing is installed, and an outside air introduction hole is provided at a lower portion of the housing in the state in which the housing is installed.

A gas diffusion mechanism may be provided at the upper portion of the housing.

A plurality of the gas discharge holes may be provided at the upper portion of the housing.

A partition that adjusts a flow of gas may be provided inside the housing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an external perspective view of a fuel cell system 10;

FIG. 2 illustrates the configuration of a fuel cell unit 100;

FIG. 3 illustrates a first embodiment (Example 1-1);

FIG. 4 illustrates the first embodiment (Example 1-2);

FIG. 5 illustrates the first embodiment (Example 1-3);

FIG. 6 illustrates a second embodiment;

FIG. 7 illustrates a third embodiment (Example 3-1);

FIG. 8A illustrates the third embodiment (Example 3-2); and

FIG. 8B illustrates the third embodiment (Example 3-2).

### DETAILED DESCRIPTION OF EMBODIMENTS

### 1. First Embodiment

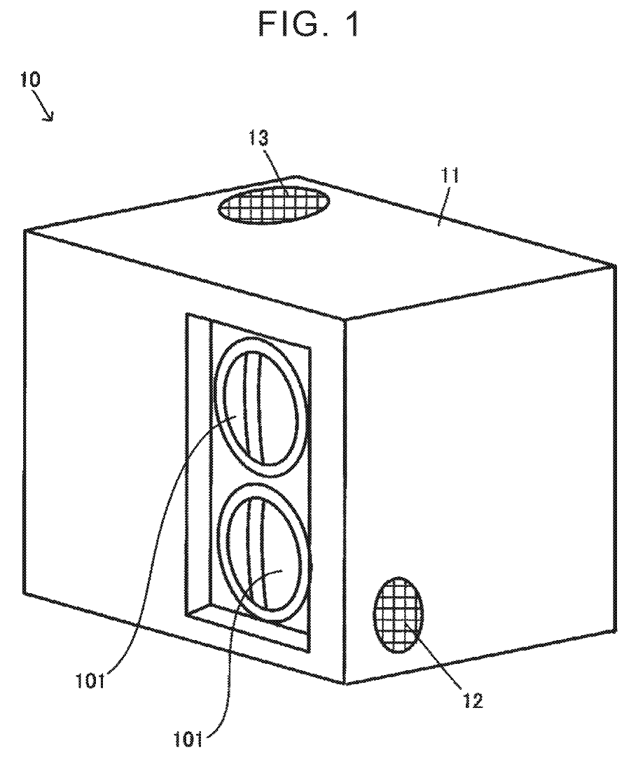

FIG. 1 is an external perspective view of a fuel cell system 10 according to a first embodiment. The fuel cell system 10 includes a box-shaped housing 11 that forms an outer shell, and the housing 11 houses various devices (fuel cell unit) for generating electric power using a fuel cell.

### 1.1. Fuel Cell Unit

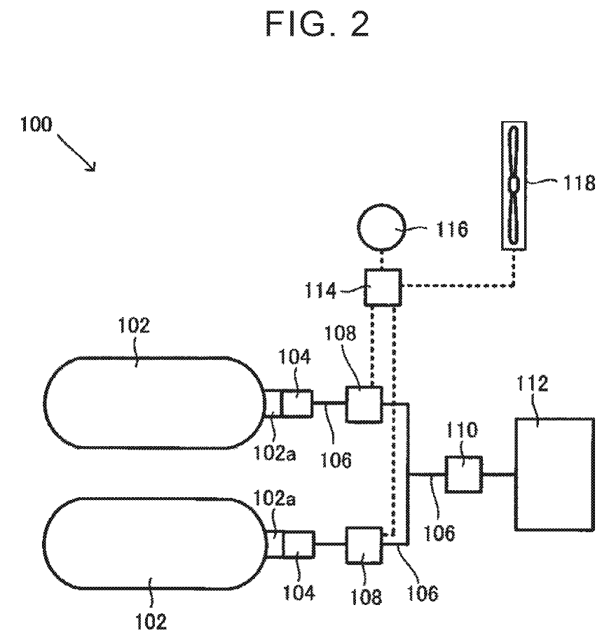

FIG. 2 conceptually shows the configuration of a fuel cell unit 100 disposed inside the housing 11. FIG. 2 is a conceptual diagram illustrating the configuration of the fuel cell unit 100, and does not show the positional relationship of the disposition of components inside the housing 11.

The fuel cell unit 100 is a device that includes detachable hydrogen tanks 102 filled with hydrogen (part of which is also shown in FIG. 1), and that uses hydrogen supplied from the hydrogen tanks 102 as fuel and combines it with air taken in from the outside to generate electric power in a fuel cell. Such power generation is publicly known.

In the present embodiment, the fuel cell unit 100 includes the hydrogen tanks 102, connection portions 104, hydrogen supply pipes 106, electromagnetic valves 108, an injector 110, a fuel cell 112, a control device 114, a hydrogen detection sensor 116, and a circulator 118. Various other devices such as a pressure sensor, a filter, a check valve, and a pressure reducing valve may be provided as needed.

The connection portion 104 is a member that detachably connects the hydrogen tank 102 and the hydrogen supply pipe 106, and is detachably connected to an on-off valve 102a of the hydrogen tank 102 and is also connected to the hydrogen supply pipe 106.

The connection portion 104 acts on the on-off valve 102a of the hydrogen tank 102 to operate the on-off valve 102a to open or close. Therefore, the connection portion 104 includes, for example, a push rod.

The hydrogen supply pipe 106 is a pipe constituting a path that guides hydrogen in the hydrogen tank 102 from the connection portion 104 to the fuel cell 112. Therefore, the connection portion 104 is disposed near the hydrogen tank 102 on the hydrogen supply pipe 106.

In the present embodiment, the hydrogen supply pipes 106 extending from the connection portions 104 for the two hydrogen tanks 102 join together into a single hydrogen supply pipe 106 that is connected to the fuel cell 112.

The electromagnetic valve 108 is disposed on the hydrogen supply pipe 106 and switches permission and restriction of hydrogen supply. This switching is performed by a command signal from the control device 114.

The injector 110 is disposed on the hydrogen supply pipe 106 between the connection portions 104 and the fuel cell 112 and controls the hydrogen supply to the fuel cell 112. Although the specific form of the injector is not particularly limited, a flow control valve can be given.

The fuel cell 112 is a device that consumes supplied hydrogen, and is supplied with hydrogen from the hydrogen tank 102. The fuel cell 112 is supplied with hydrogen and with air through an air hole (not shown) to generate electric power. The specific configuration of the fuel cell 112 is not particularly limited, and known configurations can be used.

The control device 114 is a device that controls the fuel cell system, and can be configured by a computer. In the present embodiment, the control device 114 is further configured to transmit and receive signals to and from the electromagnetic valves 108, the hydrogen detection sensor 116, and the circulator 118.

The hydrogen detection sensor 116 is a sensor that detects hydrogen, and is configured to transmit a detection result to the control device 114 as a signal.

The circulator 118 functions as a hydrogen diffusion mechanism, and is configured such that its operation and halt are controlled by receiving signals from the control device 114.

### 1.2. Housing

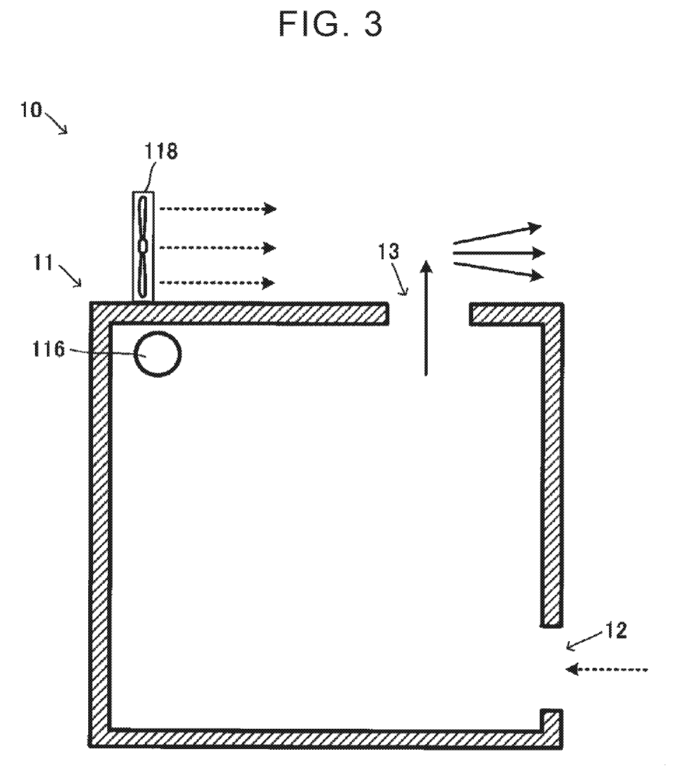

The housing 11 is a box-shaped member that houses the components of the fuel cell unit 100. FIG. 3 is a sectional view illustrating the housing 11 in Example 1-1 of the first embodiment described later. FIG. 3 shows the hydrogen detection sensor 116 and the circulator 118 of the housed fuel cell unit 100, and the other components are omitted.

As can be seen from FIG. 3, the housing 11 has an outside air introduction hole 12 and a discharge hole 13.

The outside air introduction hole 12 is a hole for introducing outside air into the housing 11, and is provided at a lower portion of the housing 11. In FIG. 3, the outside air introduction hole 12 is provided at a lower portion of one side wall of the rectangular parallelepiped housing 11. For example, when the bottom wall has a clearance from the installation floor, outside air can be introduced into the housing 11 from the outside. Therefore, the outside air introduction hole 12 may be provided in the bottom wall.

The discharge hole 13 is a hole 13 for discharging hydrogen that leaks and is present inside the housing 11 from the inside of the housing 11 to the outside. Since hydrogen is lighter than air and tends to accumulate at an upper portion inside the housing 11, it is preferable that the discharge hole 13 be provided in the ceiling wall of the housing 11 as shown in FIG. 3. However, the present disclosure is not limited to this, and the discharge hole 13 may be provided at an upper portion of one side wall of the rectangular parallelepiped housing 11.

Since the outside air introduction hole 12 is provided at the lower portion of the housing 11 and the discharge hole 13 is provided at the upper portion of the housing 11, light hydrogen that leaks from the fuel cell unit 100 and flows into the housing 11 is discharged to the outside through the discharge hole 13 located at the upper portion, and instead, outside air is introduced into the housing 11 through the outside air introduction hole 12 located at the lower portion.

### 1.3. Hydrogen Diffusion Configuration (Example 1-1)

In the present example shown in FIG. 3, the hydrogen detection sensor 116 is disposed at an upper portion inside the housing 11. The circulator 118 is disposed at the upper portion of the housing 11, and is configured such that the flow of fluid caused by the circulator 118 is directed toward the discharge hole 13.

In the present example, when hydrogen leaks from the fuel cell unit 100, the leaked hydrogen is light and therefore moves to the upper portion inside the housing 11 and is discharged through the discharge hole 13. When the leaked hydrogen reaches the upper portion inside the housing 11 and the hydrogen detection sensor 116 detects a hydrogen concentration equal to or higher than a predetermined value, the control device 114 closes the electromagnetic valves 108 to suppress further hydrogen leakage and operates the circulator 118. The flow of fluid caused by the circulator 118 is directed toward the hydrogen discharged through the discharge hole 13. Therefore, the hydrogen is diffused and the concentration can be reduced. Thus, the problem with high concentration hydrogen can be addressed.

### 1.4. Hydrogen Diffusion Configuration (Example 1-2)

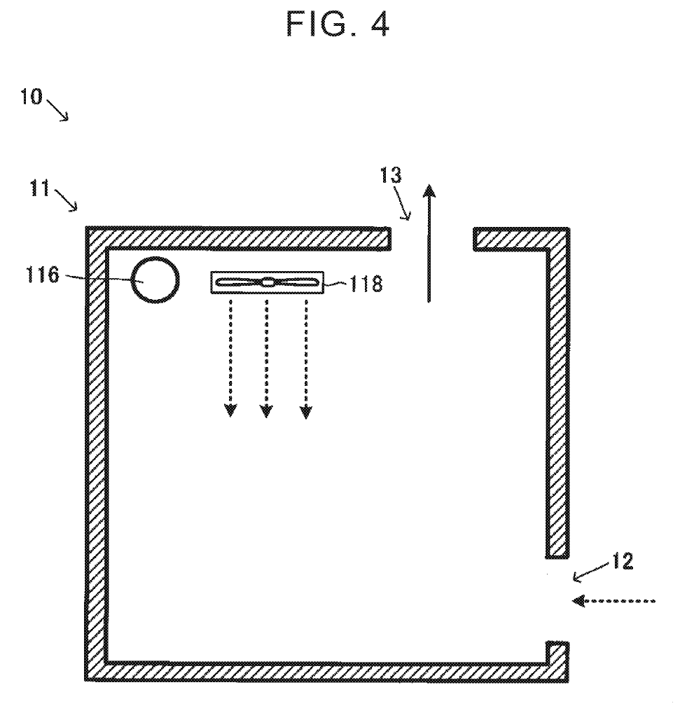

FIG. 4 illustrates Example 1-2 of the first embodiment. FIG. 4 is a diagram from the same viewpoint as in FIG. 3. In the present example as well, the outside air introduction hole 12 and the discharge hole 13 are provided and the hydrogen detection sensor 116 is disposed at the upper portion inside the housing 11. In the present example, the circulator 118 is disposed at the upper portion inside the housing 11, and is configured such that the flow caused by the circulator 118 is directed downward.

In the present example, when hydrogen leaks from the fuel cell unit 100, the leaked hydrogen moves to the upper portion inside the housing 11 and is discharged through the discharge hole 13. When the leaked hydrogen reaches the upper portion inside the housing 11 and the hydrogen detection sensor 116 detects a hydrogen concentration equal to or higher than a predetermined value, the control device 114 closes the electromagnetic valves 108 to suppress further hydrogen leakage and operates the circulator 118. Since the flow of air caused by the circulator 118 is directed downward inside the housing 11, the hydrogen is stirred inside the housing 11 and the concentration can be reduced. The hydrogen with the reduced concentration is discharged through the discharge hole 13. Thus, the problem with high concentration hydrogen can be addressed.

In this case, a fan may be provided in the outside air introduction hole 12 or the discharge hole 13 to promote forced discharge.

### 1.5. Hydrogen Diffusion Configuration (Example 1-3)

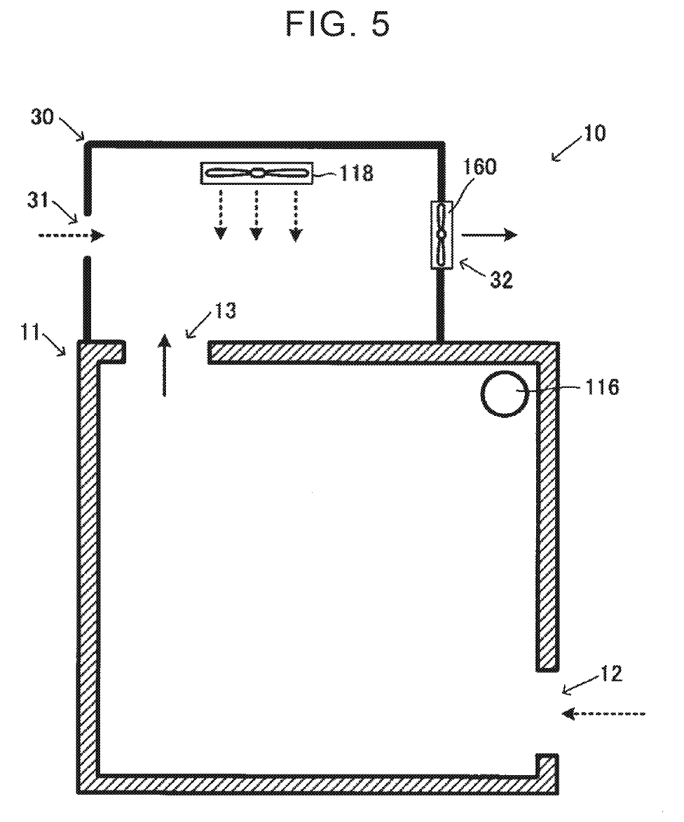

FIG. 5 illustrates Example 1-3 of the first embodiment. FIG. 5 is a diagram from the same viewpoint as in FIG. 3. In the present example, the outside air introduction hole 12, the discharge hole 13, the hydrogen detection sensor 116, and the circulator 118 are provided as in Example 1-1.

In the present example, a box-shaped chamber 30 is further disposed at upper portion of the housing 11, and is configured such that the fluid discharged through the discharge hole 13 flows into the chamber 30. The chamber 30 has an outside air introduction hole 31 for introducing outside air, and a discharge hole 32 for exhausting gas from the inside of the chamber 30 to the outside. A fan 160 that is one gas diffusion mechanism is disposed in the discharge hole 32.

In the present example, the circulator 118 is disposed inside the chamber 30 to stir the fluid inside the chamber 30.

In the present example, when hydrogen leaks from the fuel cell unit 100, the leaked hydrogen moves to the upper portion inside the housing 11 and is discharged through the discharge hole 13. When the leaked hydrogen reaches the upper portion inside the housing 11 and the hydrogen detection sensor 116 detects a hydrogen concentration equal to or higher than a predetermined value, the control device 114 closes the electromagnetic valves 108 to suppress further hydrogen leakage and operates the circulator 118 and the fan 160. The fluid discharged through the discharge hole 13 by the operation of the fan 160 moves through the chamber 30. At this time, the fluid is stirred by the circulator 118 together with the outside air flowing in through the outside air introduction hole 31. Therefore, the hydrogen concentration is reduced. The fluid with the reduced hydrogen concentration is then discharged through the discharge hole 32 via the fan 160. Accordingly, the hydrogen with the reduced concentration is discharged through the discharge hole 32. Thus, the problem with high concentration hydrogen can be addressed.

### 2. Second Embodiment

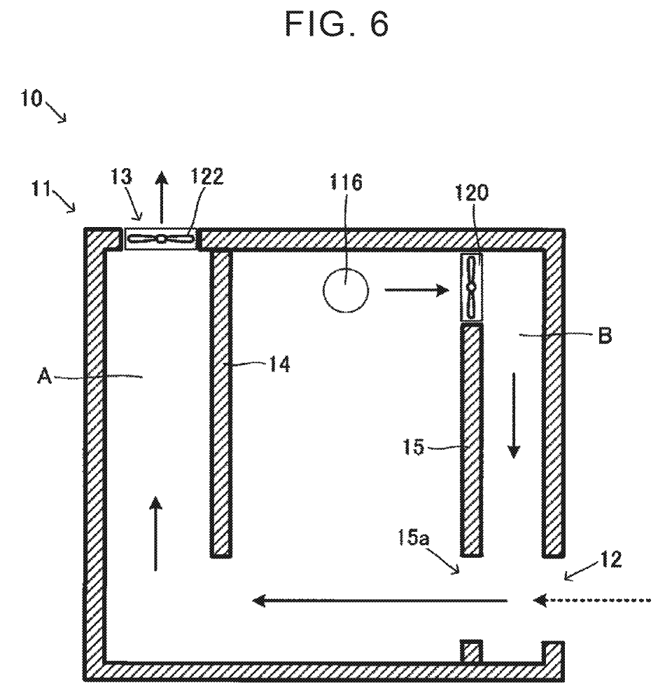

FIG. 6 illustrates a fuel cell system 10 according to a second embodiment. FIG. 6 is a diagram from the same viewpoint as in FIG. 3 used to illustrate the first embodiment. In the second embodiment, a circulation fan 120 and an exhaust fan 122 are used as the gas diffusion mechanism instead of the circulator 118 of the fuel cell unit 100 of the first embodiment. The other components are the same as those in the first embodiment.

In the present embodiment as well, the housing 11 has the outside air introduction hole 12 and the discharge hole 13. In the present embodiment, the outside air introduction hole 12 and the discharge hole 13 are located opposite to each other in a horizontal direction in a predetermined cross section.

In the present embodiment, the housing 11 includes two partition plates 14, 15 extending in an up-down direction inside the housing 11.

The partition plate 14 is disposed close to the discharge hole 13 and has a clearance between the bottom end thereof and the bottom surface of the housing 11. Therefore, a channel A is formed between the side wall of the housing 11 and the partition plate 14 from the lower portion of the housing 11 toward the discharge hole 13 at the upper portion.

The partition plate 15 is disposed close to the outside air introduction hole 12 and has a clearance between the upper end thereof and the ceiling. Therefore, a channel B is formed between the side wall of the housing 11 and the partition plate 15 from the upper portion of the housing 11 toward the lower portion of the housing 11. The partition plate 15 has a hole 15a located to face the outside air introduction hole 12.

In the present embodiment, the circulation fan 120 is disposed in the clearance between the partition plate 15 and the ceiling surface of the housing 11 to direct the fluid toward the channel B. The exhaust fan 122 is disposed in the discharge hole 13 such that the fluid flows from the channel A to the outside.

In the present embodiment, when hydrogen leaks from the fuel cell unit 100, the leaked hydrogen moves to the upper portion inside the housing 11. When the leaked hydrogen reaches the upper portion inside the housing 11 and the hydrogen detection sensor 116 detects a hydrogen concentration equal to or higher than a predetermined value, the control device 114 closes the electromagnetic valves 108 to suppress further hydrogen leakage and operates the circulation fan 120 and the exhaust fan 122. Therefore, the hydrogen flows into the channel B by the circulation fan 120 and moves to the lower portion of housing 11. The hydrogen concentration is reduced by the outside air from the outside air introduction hole 12. The hydrogen reaches the lower portion of the channel A through the hole 15a. The hydrogen with the reduced concentration that reaches the lower portion of the channel A is moved by the exhaust fan 122 through the channel A to the upper portion of the housing 11 and is discharged to the outside. Accordingly, the hydrogen with the reduced concentration is discharged through the discharge hole 13. Thus, the problem with high concentration hydrogen can be addressed.

### 3. Third Embodiment

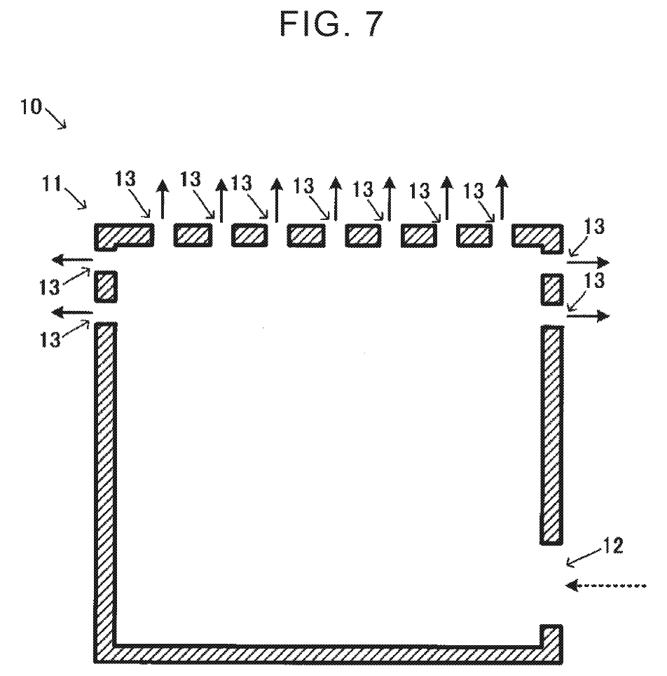

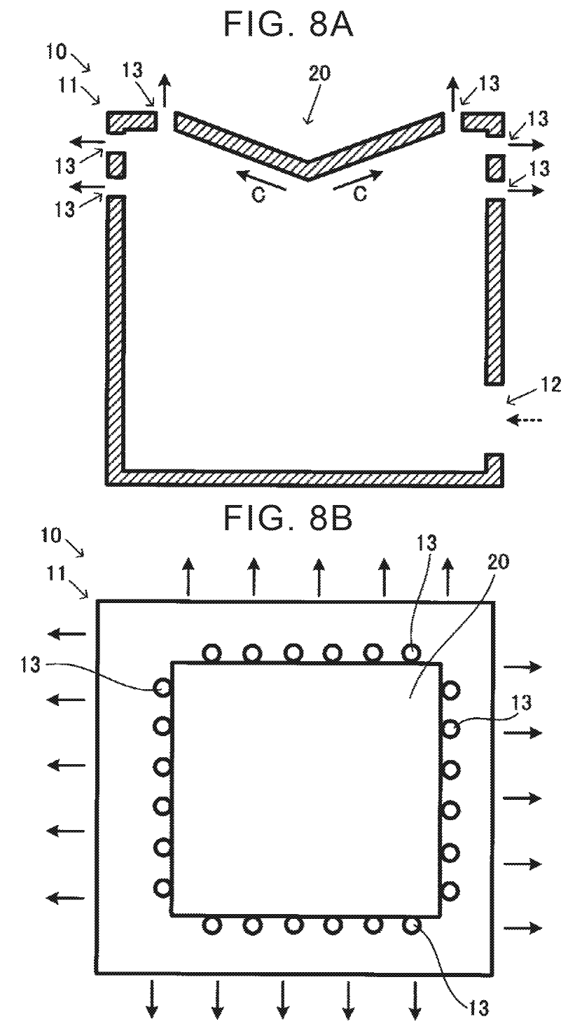

FIGS. 7, 8A and 8B illustrate a fuel cell system 10 according to a third embodiment. FIGS. 7 and 8A are diagrams from the same viewpoint as in FIG. 3 used to illustrate the first embodiment. FIG. 8B is a plan view (view from above) of the fuel cell system 10.

In the third embodiment, the hydrogen detection sensor 116 and the circulator 118 of the fuel cell unit 100 in the first embodiment are not provided. The other components are the same as those in the first embodiment.

### 3.1. Example 3-1

FIG. 7 shows Example 3-1 of the third embodiment. In the present example as well, the housing 11 has the outside air introduction hole 12 and the discharge hole 13. In the present example, a plurality of discharge holes 13 is provided over the entire surface of the ceiling of the housing 11 and in part of the upper portions of the side walls of the housing 11. A punched metal may be used as an example of forming such holes.

In the present example, when hydrogen leaks from the fuel cell unit 100, the leaked hydrogen moves to the upper portion inside the housing 11 and is diffused and discharged to the outside through the discharge holes 13. Accordingly, the hydrogen is sequentially discharged through the discharge holes 13 without an increase in concentration. Thus, the problem with high concentration hydrogen can be addressed. According to the present example, there is no need to use the hydrogen detection sensor or the circulator, and the device can be simplified.

### 3.2. Example 3-2

FIGS. 8A and 8B show Example 3-2 of the third embodiment. In the present example, a recess 20 is provided at the center of the ceiling of the housing 11 to protrude inward of the housing 11. Therefore, the housing 11 includes inclined surfaces that are inclined upward from the center toward the outer periphery inside the housing 11.

In the present example as well, the housing 11 has the outside air introduction hole 12 and the discharge hole 13. In the present example, a plurality of discharge holes 13 is provided along the outer periphery of the recess 20 in the ceiling of the housing 11 and in part of the upper portions of the side walls of the housing 11. A punched metal may be used as an example of forming such holes.

In the present example as well, when hydrogen leaks from the fuel cell unit 100, the leaked hydrogen moves to the upper portion inside the housing 11. At this time, the hydrogen that has reached the recess 20 moves along the inclined surfaces of the recess 20 toward the outer periphery as indicated by arrows C while being dispersed, and is discharged to the outside through the discharge holes 13. Accordingly, the hydrogen is sequentially discharged by the recess 20 through the discharge holes 13 without an increase in concentration. Thus, the problem with high concentration hydrogen can be addressed. According to the present example, there is no need to use the hydrogen detection sensor or the circulator, and the device can be simplified.

### 3.3. Others

In Examples 3-1 and 3-2, the hydrogen detection sensor and the circulator are not used due to the advantage of simplification, but the present disclosure is not limited to this. The diffusion and discharge of hydrogen may be promoted using the hydrogen detection sensor and the circulator.

What is claimed is:

1. A fuel cell system comprising a housing and a fuel cell disposed inside the housing, wherein
a gas discharge hole and a hydrogen detection sensor are provided at an upper portion of the housing in a state in which the housing is installed, and an outside air introduction hole is provided at a lower portion of the housing in the state in which the housing is installed.

2. The fuel cell system according to claim 1, wherein a gas diffusion mechanism is provided at the upper portion of the housing.

3. The fuel cell system according to claim 1, wherein a plurality of the gas discharge holes is provided at the upper portion of the housing.

4. The fuel cell system according to claim 1, wherein a partition that adjusts a flow of gas is provided inside the housing.
